(19) United States
(12) Patent Application Publication
(10) Pub. No.: US 2005/0201238 A1
(43) Pub. Date: Sep. 15, 2005

(54) Method and device for discriminating deflecting disc

(75) Inventor: Jae-hyun Kim, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd, Suwon-si (KR)

(21) Appl. No.: 11/017,747

(22) Filed: Dec. 22, 2004

(30) Foreign Application Priority Data
Mar. 9, 2004 (KR) 2004-15720

(51) Int. Cl. G11B 7/00

(52) U.S. Cl. 369/53.23

(57) ABSTRACT

A device and method for discriminating a deflecting disc. A method of discriminating a deflecting disc from a general optical disc includes: sensing a focus error signal generated when an optical pickup is at a specified position over a disc, and checking the focus error signal in a real time mode; measuring amplitudes of the focus error signal a specified number of times after a lapse of a specified amount of time after the pickup arrives at the specified position, specified and calculating an average value of the amplitudes of the focus error signal; and comparing the average value of the amplitudes of the focus error signal with a specified standard value. When the average value of the amplitudes of the focus error signal exceeds the specified standard value, the optical disc is determined to be a deflecting disc, and when the average value of the amplitudes of the focus error signal is less than the specified standard value, the optical disc id determined to be a general optical disc.

### CROSS-REFERENCE TO RELATED APPLICATION

This application claims benefit under 35 U.S.C. § 119 from Korean Patent Application No. 2004-15720, filed on Mar. 9, 2004, the disclosure of which is incorporated herein by reference.

### BACKGROUND OF THE INVENTION

1. Field of the Invention

The present invention relates to a method of and device for discriminating a deflecting disc, and more particularly, to a method and device to more accurately discriminate a deflecting disc using a fact that focal distance of the deflecting disc is different from that of a normal disc and thus, the deflecting disc's detection of a focus error signal from a certain position is different the normal disc.

2. Description of the Related Art

Ever since the optical recording medium and reproducing device was developed by PHILLIPS CORP. of the Netherlands in 1978, there has been a remarkable technical advance both in the optical recording media and in semiconductors. Of late, a variety of optical recording media, such as CD (Compact Disc), CD-ROM (Compact Disc—Read Only Memory), CD-R/W (Compact Disc ReWritable), and DVD (Digital Versatile Disc), have become broadly used products.

In general, an optical recording/reproducing technique for use with an optical disc (hereinafter it is referred to as a “disc”) analyzes the variation of reflected light of a laser beam to read out data from the optical disc. Methods for recording data on the disc by differentiating the reflected light utilize interference between a reference surface and a pit sunken into the disc substrate, or a change in the direction of a polarized light of a magneto-optical recording medium (e.g., a magneto-optical disc), or variation of organic dye as is used in a phase change CD-RW (CD-ReWritable). Particularly, the phase change method, mainly because of its capability of repetitive recording and reproducing, is widely applied to CDs (Compact Discs) or DVDs (Digital Video Discs or Digital Versatile Discs).

Optical recording media are largely divided into normal discs and deflection discs, depending on thickness. A deflecting disc joggles horizontally during rotation, so it is very difficult to accurately focus and have a perfect control on the focal distance.

One thing to be preceded before having a better control on the focal distance of the deflection disc is discriminating whether or not the disc currently being used with recording or reproducing is a deflecting disc.

However, discrimination of a deflecting disc is relatively hard and harder than discrimination of the eccentric disc. For example, when there is a track error, a sine wave always appears as a result of the off-track of a laser beam. However, when a focus error is detected, a laser beam is out of the “S” curve of the sine wave and the level of the error becomes “0.” In this case, no signal is shown.

For the above problems, the deflecting disc is not usually discriminated, but the amplitude of a focus error signal is measured instead. But its impact on deflection is so slight that the ability to discriminate is lowered.

### BRIEF SUMMARY

It is, therefore, an aspect of the present invention to provide a method and device for discriminating a deflecting disc from general optical discs, wherein an average amplitude of a focus error signal is compared to a specified standard value and if the average amplitude of the focus error signal exceeds the specified standard value, the optical disc is discriminated as a deflecting disc.

According to an aspect of the present invention, there is provided method of discriminating a deflecting disc from a general optical disc, including: sensing a focus error signal generated when an optical pickup is at a specified position over a disc, and checking the focus error signal in a real time mode; measuring amplitudes of the focus error signal a specified number of times after a lapse of a specified amount of time after the pickup arrives at the specified position, specified and calculating an average value of the amplitudes of the focus error signal; and comparing the average value of the amplitudes of the focus error signal with a specified standard value, and when the average value of the amplitudes of the focus error signal exceeds the specified standard value, discriminating the optical disc as a deflecting disc, and when the average value of the amplitudes of the focus error signal is less than the specified standard value, discriminating the optical disc as a general optical disc.

The specified amount of time may be approximately 50 ms.

The optical disc may be a CD or a DVD.

According to another aspect of the present invention, there is provided a device for discriminating a deflecting disc from a general optical disc, including: a pickup which is movable to a specified position over a disc where a focus error signal is generated; DSP which measures amplitudes of the focus error signal a specified number of times after a lapse of a specified amount of time after the pickup arrives at the specified position, and calculates an average value of the amplitudes of the focus error signal; and a micom which compares the average value of the amplitudes of the focus error signal to a specified standard value, and when the average value of the amplitudes of the focus error signal exceeds the specified standard value, discriminating the optical disc as a deflecting disc, and when the average value of the amplitudes of the focus error signal is less than the specified standard value, discriminating the optical disc as a general optical disc.

The specified position may be where the focus error signal is generated, and may be between about several hundreds of μm to several mm.

The specified amount of time may be approximately 50 ms.

The optical disc may be a CD or a DVD.

According to another aspect of the present invention, there is provided a method, including: moving a pickup to a specified position over an optical disc; checking a focus error signal (FES) in a real time mode, after the moving; measuring amplitudes of the FES and calculating an average thereof, after a specified amount of time; and determining a type of the disc based on the calculated average.

According to another aspect of the present invention, there is provided a method of discriminating a deflecting disc from a general optical disc, including: measuring amplitudes of the focus error signal a specified number of times after a lapse of a specified amount of time after a pickup arrives at the specified position over a disc where a focus error signal is generated and calculating an average value of the amplitudes of the focus error signal; and comparing the average value of the amplitudes of the focus error signal with a specified standard value, and when the average value of the amplitudes of the focus error signal exceeds the specified standard value, discriminating the optical disc as a deflecting disc, and when the average value of the amplitudes of the focus error signal is less than the specified standard value, discriminating the optical disc as a general optical disc.

According to another aspect of the present invention, there is provided a device for discriminating a deflecting disc from a general optical disc. The device includes a digital signal processor (DSP) which measures amplitudes of a focus error signal a specified number of times after a lapse of a specified amount of time after a pickup arrives at a specified position where a focus error signal is generated, and calculates an average value of the amplitudes of the focus error signal, the average value being comparable to a specified standard value. When the average value of the amplitudes of the focus error signal exceeds the specified standard value, discriminating the optical disc as a deflecting disc. When the average value of the amplitudes of the focus error signal is less than the specified standard value, discriminating the optical disc as a general optical disc.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an optical disc reproducing device for discriminating a deflecting disc according to an embodiment of the present invention; and

FIG. 2 is a flow chart describing a method for discriminating a deflecting disc according to an embodiment of the present invention.

### DETAILED DESCRIPTION OF EMBODIMENT

Reference will now be made in detail to an embodiment of the present invention, examples of which are illustrated in the accompanying drawings, wherein like reference numerals refer to the like elements throughout. The embodiment is described below to explain the present invention by referring to the figures.

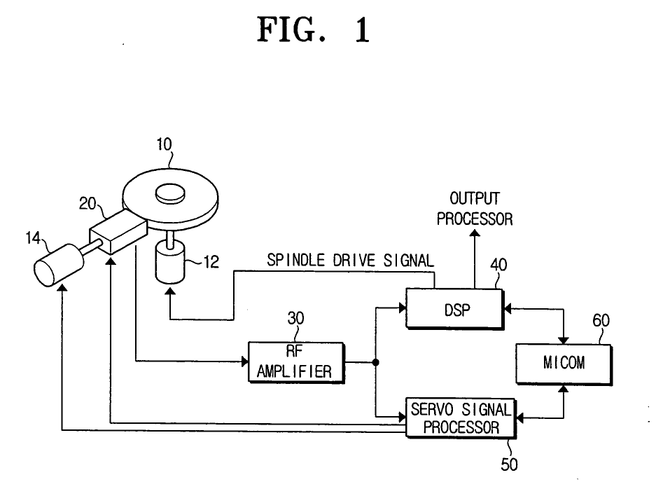

FIG. 1 is a block diagram of an optical disc reproducing device for discriminating a deflecting disc according to an embodiment of the present invention. Referring to FIG. 1, a pickup 20 reads an optical signal from an optical disc 10 where data is stored, converts the optical signal to an electrical RF (Radio Frequency) signal, and outputs the RF signal to an RF amplifier 30.

The pickup 20 is driven by a focus actuator (not shown) for performing focus servo operations and a tracking actuator (not shown) for performing tracking servo operations. The tracking servo causes the pickup 20 to follow the track on the optical disc 10, and the focus servo maintains the pickup 20 for the optical disc 10 in a focus “on” state.

Under the control of a servo signal processor 50, the focusing actuator moves an objective lens to an optical axis direction (vertical direction), and the tracking actuator moves the optical disc 10 to the radial direction of the objective lens, thereby allowing the pickup 20 to follow the track.

A spindle motor 12, which is driven in response to a spindle drive signal inputted from a DSP (Digital Signal Processor) 40, spins the optical disc 10 at CLV (Constant Linear Velocity) or CAV (Constant Angular Velocity). A sled feed motor 14, which is driven by a sled feed servo control of the servo signal processor 50, carries the pickup 20 to the radial direction on the optical disc 10.

The RF amplifier 30 amplifies an output signal of the pickup 20, removes noises and distortion from the amplified signal using a waveform equalization circuit, and transfers the waveform-fixed signal to a digital signal processor (DSP) 40. Also, the RF amplifier 30 has a built-in focus error detection circuit (not shown) and a tracking error detection circuit (not shown), and generates signals for focus servo and tracking servo operations, namely a Focus Error Signal (FES) and a Tracking Error Signal (TES), and outputs them to the DSP 40 and the servo signal processor 50.

The DSP 40 demodulates data from the EFM signal transferred from the RF amplifier 30, carries out error correction, and outputs the data to an output processor. The DSP 40 checks focus error signals in real time mode, and measures amplitudes of the focus error signals for a certain number of times after a lapse of a specified amount of time. Based on the FES measurement, the DSP 40 calculates an average value of the FES.

The output processor processes data outputted from the DSP 40 and generates a final output signal such as a video signal.

Meanwhile, a micom 60 is equipped with ROM storing a control program according to an embodiment of the present invention, and RAM temporarily storing data generated from the control process. Thus, micom 60 has a control over the general operations for data reproduction.

Under the control of the micom 60, the servo signal processor 50 carries out focus servo and tracking servo operations for the pickup 20, and sled feed servo operations for the sled feed motor 14, in response to servo control associated signals (TES, FES) outputted from the RF amplifier 30.

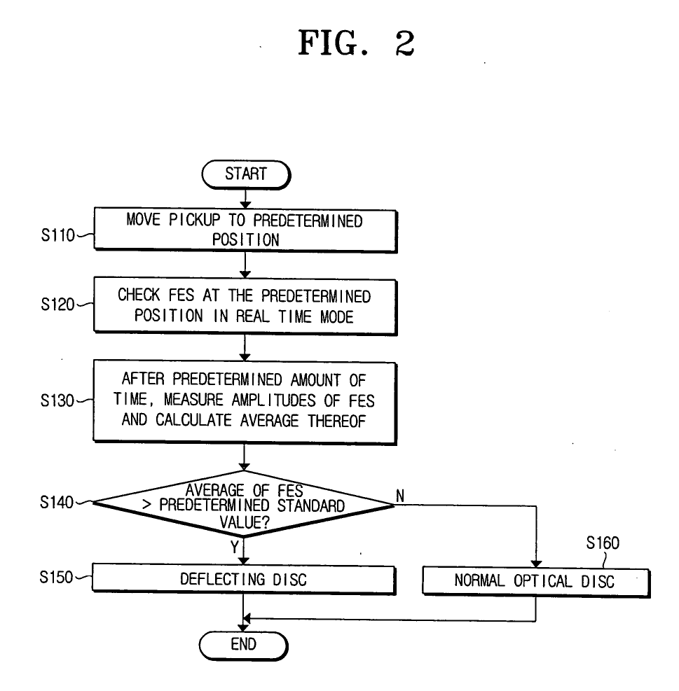

FIG. 2 is a flowchart illustrating a method of discriminating a deflecting disc according to an embodiment of the present invention. In general, the first thing to be done for proper signal pickup from an optical disc is to adjust the position of an objective lens of the optical disc reproducing device so that an optical disc reflecting surface is located within the depth of focus. Typically this action is called focusing servo control. All servo controls involved in signal reproduction do not start until the focusing state is in a focus “on” state.

Referring to FIGS. 1 and 2, the pickup 20, under the control of the micom 60, moves from its reference position to a specified position for discriminating deflection (S110). That is, the micom 60 drives the objective lens in the vertical direction to move the pickup 20 to the specified position and thus, induces generation of a focus error signal (FES). Here, the reference position indicates a position of the pickup 20 before it is set in a focus “on” state.

The specified position for discriminating deflection is a position where the FES of a deflecting disc is detected. Usually the detection position is specified by a manufacturer through tests, and ranges from several hundreds of μm to several mm.

As described above, the FES is generated when the pickup 20 is in focus “on” state. In other words, the FES is generated when a laser beam converged by the objective lens forms an image near to the focus. Therefore, if the image of the convergent laser beam by the objective lens precisely coincides with the focus or falls out of a certain range from the focus, the FES is not generated.

Thusly generated focus error signals at the specified position are checked by the DSP 40 in a real time mode (S120). According to the embodiment shown in FIG. 1, the DSP 40 is implemented as an independent unit of the servo signal processor 50. However, the DSP 40 can be embedded in the servo signal processor 50.

About 50 ms after the pickup 20 has moved to the detection position of the FES of the deflecting disc, the DSP 40 measures the amplitude of the FES for a specified number of times. Then, the DSP 40 averages the measurement of the FES and calculates an average value of the FES (S130). This is carried out in order to exclude noises generated by early vibrations of the pickup 20 from the detection object. Preferably, the measurement is performed approximately 512 times.

The micom 60 compares the average value of the FES to a specified standard value (S140). If the average value of the FES is greater than the specified standard value, the optical disc is discriminated as a deflecting disc (S150). However, if the average value of the FES is less than the specified standard value, the optical disc is discriminated as a general optical disc (S160). In this manner, it is possible to discriminate deflecting discs from general optical discs.

As explained above, the method of discriminating the deflecting disc of the present embodiment can be advantageously used for discriminating deflecting discs and can be applied to a variety of systems.

Although an embodiment of the present invention has been shown and described, it would be appreciated by those skilled in the art that changes may be made in the embodiment without departing from the principles and spirit of the invention, the scope of which is defined by the claims and their equivalents.

1. A method of discriminating a deflecting disc from a general optical disc, comprising:
sensing a focus error signal generated when an optical pickup is at a specified position over a disc, and checking the focus error signal in a real time mode;
measuring amplitudes of the focus error signal a specified number of times after a lapse of a specified amount of time after the pickup arrives at the specified position, and calculating an average value of the amplitudes of the focus error signal; and
comparing the average value of the amplitudes of the focus error signal with a specified standard value, and when the average value of the amplitudes of the focus error signal exceeds the specified standard value, discriminating the optical disc as a deflecting disc, and when the average value of the amplitudes of the focus error signal is less than the specified standard value, discriminating the optical disc as a general optical disc.

2. The method according to claim 1, wherein the specified position is a position where the focus error signal is generated, and is between about several hundreds of μm to several mm from a surface of the disc.

3. The method according to claim 1, wherein the specified amount of time is approximately 50 ms.

4. The method according to claim 1, wherein the optical disc is a CD or a DVD.

5. A device for discriminating a deflecting disc from a general optical disc, comprising:
a pickup which is movable to a specified position over a disc where a focus error signal is generated;
DSP which measures amplitudes of the focus error signal a specified number of times after a lapse of a specified amount of time after the pickup arrives at the specified position, and calculates an average value of the amplitudes of the focus error signal; and
a micom which compares the average value of the amplitudes of the focus error signal to a specified standard value, and when the average value of the amplitudes of the focus error signal exceeds the specified standard value, discriminating the optical disc as a deflecting disc, and when the average value of the amplitudes of the focus error signal is less than the specified standard value, discriminating the optical disc as a general optical disc.

6. The device according to claim 5, wherein the specified position is a position where the focus error signal is generated, and is between about several hundreds of μm to several mm from a surface of the disc.

7. The device according to claim 5, wherein the specified amount of time is approximately 50 ms.

8. The device according to claim 5, wherein the optical disc is a CD or a DVD.

9. The device according to claim 5, further comprising an RF amplifier which generates the focus error signal and outputs the focus error signal to the DSP.

10. A method, comprising:
moving a pickup to a specified position over an optical disc;
checking a focus error signal (FES) in a real time mode, after the moving;
measuring amplitudes of the FES and calculating an average thereof, after a specified amount of time; and
determining a type of the disc based on the calculated average.

11. A method of discriminating a deflecting disc from a general optical disc, comprising:
measuring amplitudes of the focus error signal a specified number of times after a lapse of a specified amount of time after a pickup arrives at the specified position over a disc where a focus error signal is generated and calculating an average value of the amplitudes of the focus error signal; and
comparing the average value of the amplitudes of the focus error signal with a specified standard value, and when the average value of the amplitudes of the focus error signal exceeds the specified standard value, discriminating the optical disc as a deflecting disc, and when the average value of the amplitudes of the focus error signal is less than the specified standard value, discriminating the optical disc as a general optical disc.

12. A device for discriminating a deflecting disc from a general optical disc, comprising:
a digital signal processor (DSP) which measures amplitudes of a focus error signal a specified number of times after a lapse of a specified amount of time after a pickup arrives at a specified position where a focus error signal is generated, and calculates an average value of the amplitudes of the focus error signal, the average value being comparable to a specified standard value, and when the average value of the amplitudes of the focus error signal exceeds the specified standard value, discriminating the optical disc as a deflecting disc, and when the average value of the amplitudes of the focus error signal is less than the specified standard value, discriminating the optical disc as a general optical disc.
